(19) United States
(12) Patent Application Publication
(10) Pub. No.: US 2017/0212447 A1
(43) Pub. Date: Jul. 27, 2017

(54) DETECT LIGHT REFLECTED FROM A DEVELOPER MEMBER OF A TONER CARTRIDGE

(71) Applicant: Hewlett-Packard Development Company, L.P., Houston, TX (US)

(72) Inventors: Jeffrey Harold Luke, Boise, ID (US); David Matthew Warnimont, Boise, ID (US)

(21) Appl. No.: 15/314,383

(22) PCT Filed: May 29, 2014
(86) PCT No.: PCT/US14/40053

§ 371 Date: Nov. 28, 2016

(51) Int. Cl. G03G 15/08

(52) U.S. Cl. CPC G03G 15/0831

(57) ABSTRACT

An image forming apparatus includes a toner cartridge, a light source, a light guiding device, and an optical sensor. The toner cartridge includes a developer member and a photosensitive member. The developer member receives toner and applies the toner to the photosensitive member. The light source emits light. The light guiding device guides the light from the light source at a plurality of areas on the developer member. The optical sensor detects an amount of reflected light reflected from the developer member.

### BACKGROUND

Image forming apparatuses such as laser printers include toner cartridge such as removable toner cartridges. The image forming apparatuses may form images on substrates using toner supplied by the toner cartridges. The toner cartridges may have a lifespan dependent on an amount of toner remaining therein.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating an image forming apparatus according to an example.

FIG. 2 is a schematic view illustrating an image forming apparatus according to an example.

FIG. 3 is a schematic view illustrating a toner cartridge of the image forming apparatus of FIG. 2 according to an example.

FIG. 4A is a schematic view illustrating the use of fiber optic cables of the image forming apparatus of FIG. 2 according to an example.

FIG. 4B is a schematic view illustrating the use of a lens assembly of the image forming apparatus of FIG. 2 according to an example.

FIG. 5 is a block diagram illustrating an image forming system according to an example.

FIG. 6 is a schematic view illustrating the image forming system of FIG. 5 according to an example.

FIG. 7 is a flowchart illustrating a method of alerting a user to replace a toner cartridge according to an example.

### DETAILED DESCRIPTION

Image forming apparatuses such as laser printers may include toner cartridges such as removable toner cartridges. The toner cartridge may have a respective lifespan dependent on an amount of toner therein. An effective amount of remaining life of the toner cartridge may be dependent upon the toner cartridge having a sufficient amount of non-damaged toner to produce an image of acceptable quality. Damaged toner, for example, may include toner that does not adhere to the developer member and, thus, does not contribute to forming an image on a substrate. For example, damaged toner may not have sufficient charge agents to enable it to be attracted onto the developer member.

At times, the toner cartridge may be used beyond its effective amount of remaining life. That is, the toner cartridge may be used to form images when there is not sufficient, non-damaged toner therein to form an image of acceptable quality. Consequently, a degraded image such as a toner faded image may be formed on a substrate. As a result, substrates with the degraded images may be discarded. Accordingly, image degradation and substrate waste may increase. Further, the throughput of the image forming apparatus may decrease.

In examples, an image forming apparatus includes a toner cartridge, a light source, a light guiding device, and an optical sensor. The toner cartridge includes a developer member and a photosensitive member. The developer member receives toner and applies the toner to the photosensitive member. The light source emits light. The light guiding device guides the light from the light source at a plurality of areas on the developer member. The optical sensor detects an amount of reflected light reflected from the developer member. The amount of reflected light detected by the optical sensor corresponds to an amount of toner on the developer member.

Thus, a user may be alerted to replace the toner cartridge in response to a determination that the amount of non-damaged toner of the toner cartridge is insufficient to produce an image of acceptable quality. That is, detecting the toner on the developer member, rather than in a toner supply hopper, and the like, can also reduce image degradation due to damaged toner, as well as image degradation caused by the depletion of good toner which has been consumed forming images through normal use of the image forming apparatus. Consequently, the user may replace the toner cartridge at its effective end of life to reduce image degradation, substrate waste, and/or inefficient use of printing time.

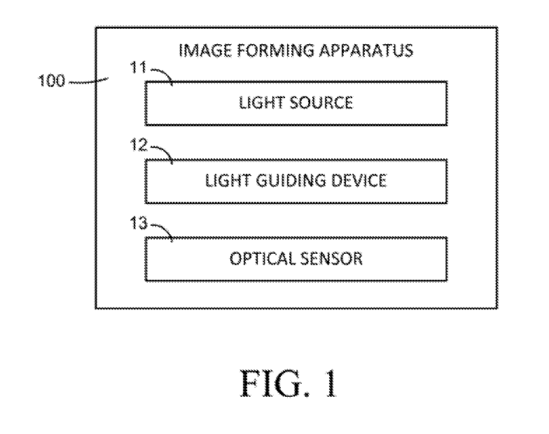

FIG. 1 is a block diagram illustrating an image forming apparatus according to an example. Referring to FIG. 1, in some examples, an image forming apparatus 100 includes a light source 11, a light guiding device 12, and an optical sensor 13. A developer member of a toner cartridge receives toner and applies the toner to a photosensitive member of the toner cartridge. The light source 11 emits light. The light guiding device 12 guides the light from the light source 11 at a plurality of areas on the developer member. The optical sensor 13 detects an amount of reflected light reflected from the developer member. In some examples, the amount of reflected light detected by the optical sensor 13 corresponds to an amount of toner on the developer member. For example, the detected amount of reflected light may correspond to whether toner is present and/or in what quantities on an area and/or respective areas of the developer member 14.

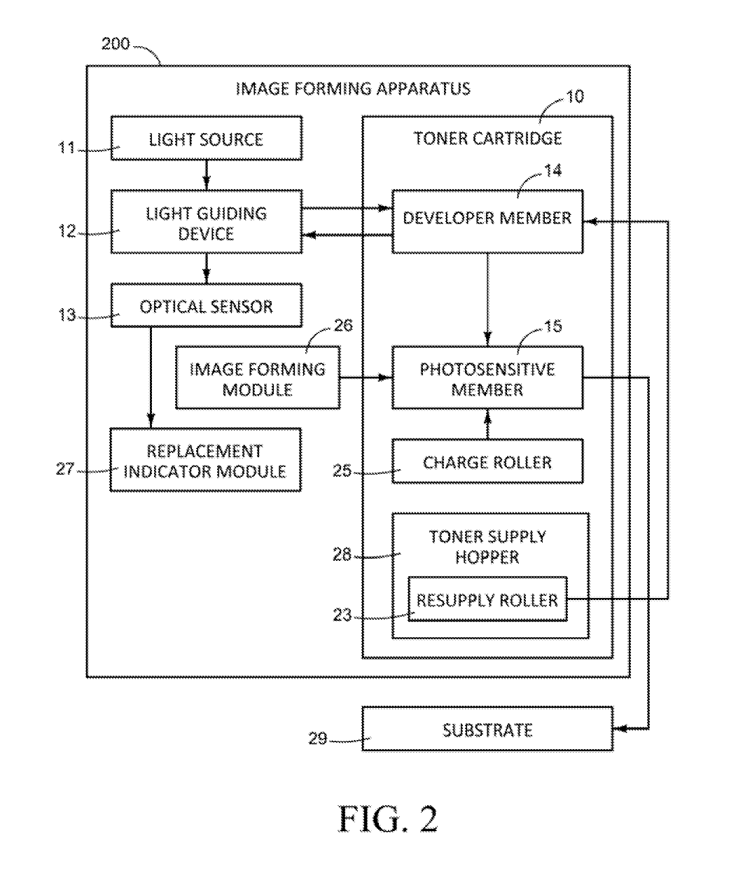

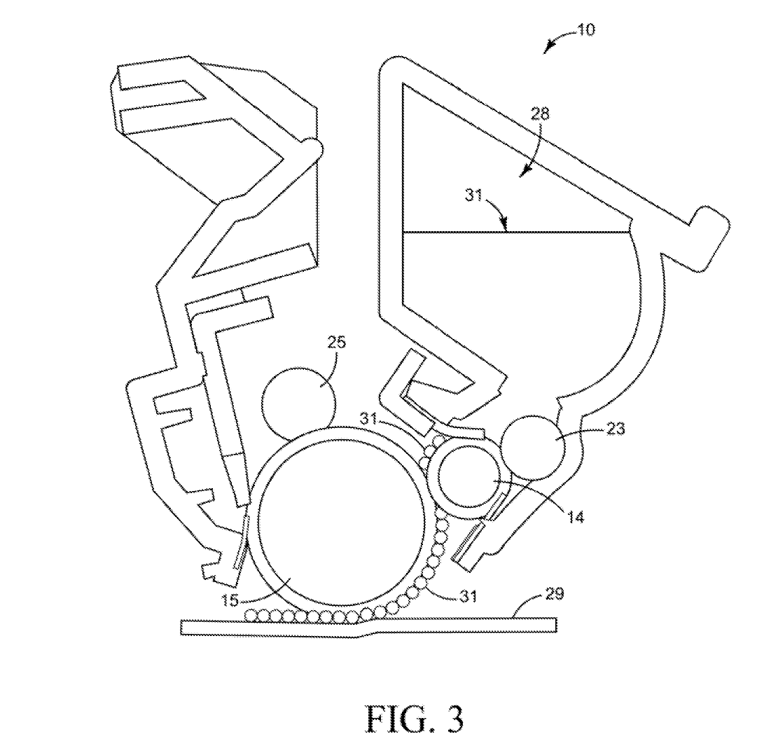

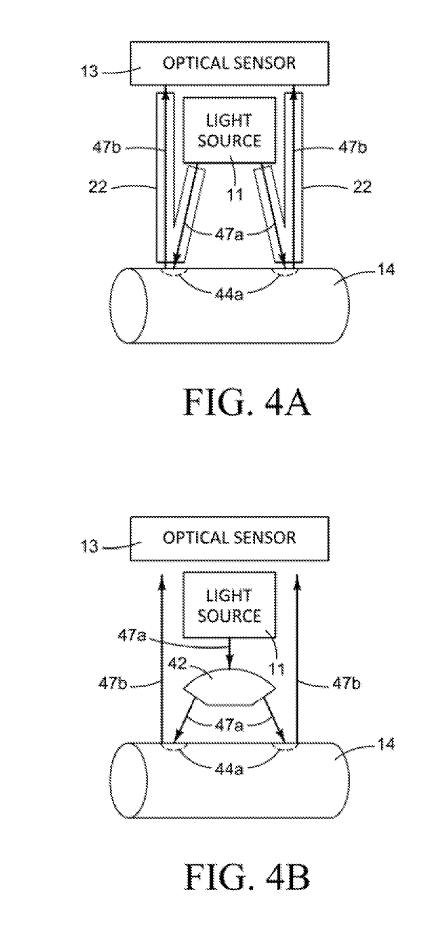

FIG. 2 is a schematic view illustrating an image forming apparatus according to an example. FIG. 3 is a schematic view illustrating a toner cartridge of the image forming apparatus of FIG. 2 according to an example. FIG. 4A is a schematic view illustrating the use of fiber optic cables of the image forming apparatus of FIG. 2 according to an example. FIG. 4B is a schematic view illustrating the use of a lens assembly of the image forming apparatus of FIG. 2 according to an example. In some examples, the image forming apparatus 200 may include the light source 11, the light guiding device 12, and the optical sensor 13 as previously discussed with respect to the image forming apparatus 100 of FIG. 1. Referring to FIGS. 2-4B, in some examples, the image forming apparatus 200 may also include a toner cartridge 10, an image forming module 26 and a replacement indicator module 27.

Referring to FIGS. 2-4B, in some examples, the toner cartridge 10 may include a developer member 14 and a photosensitive member 15. The image forming apparatus 200 may form images on a substrate 29 through a dry electrophotography process. For example, the image forming module 26 may emit light onto respective portions of the photosensitive member 15 to change a respective charge thereon to form a latent image thereon. The photosensitive member 15 may be initially charged, for example, by a charge roller 25 in contact therewith. Subsequently, an image forming module 26 such as a laser may emit light onto respective portions of the photosensitive member 15 to change the initial charge to form the latent image thereon.

Subsequently, the developer member 14 may provide toner 31 to the latent image on the photosensitive member 15 to form a developed image thereon. For example, the toner 31 may be charged opposite to the charge of the latent image and, thus, cause the toner 31 to be attracted to the latent image. In some examples, a resupply roller 23 may move the toner 31 from the toner supply hopper 28 to the developer member 14. In some examples, the image forming module 26 may include a laser and the developer member 14 may include a developer roller. The photosensitive member 15 may also transmit the toner 31 received by the developer member 14 thereon to a substrate 29 to form a printed image thereon. In some examples, the photosensitive member includes an organic photo conductor (OPC) drum.

Referring to FIGS. 2-4B, in some examples, the replacement indicator module 27 alerts a user to replace the toner cartridge 10 based on the amount of toner 31 on the developer member 14. For example, an alert to replace the toner cartridge 10 may be sent to the user in response to the amount of toner 31 on the developer member 14 being less than a toner threshold value. The toner threshold value may correspond to an acceptable amount of toner 31 on the developer member 14 with toner 31 to produce an image of acceptable quality. For example, the toner threshold value may be based on the amount of coverage of the developer member 14 by the toner such as a percentage of an external surface area of the developer member 14 which may be covered with toner 31.

In some examples, the optical sensor 13 may detect reflected light 47b along a plurality of areas 44a of the developer member 14 to determine the amount of toner coverage of the developer member 14. Further, a user may be alerted prior to the degraded image being printed on the substrate 29 to replace the toner cartridge 10 as the amount of toner 31 on the developer member 14 is used to determine whether sufficient toner is available to produce an acceptable quality image. Consequently, the user may replace the toner cartridge 10 at its effective end of life to reduce image degradation, substrate waste, and/or the inefficient use of printing time.

Referring to FIGS. 2-4B, in some examples, the replacement indicator module 27 may include machine-readable instructions to determine whether a sufficient amount of toner 31 is in the toner cartridge 10 to produce an image of acceptable quality based on the amount of reflected light 47b from the developer member 14 detected by the optical sensor 13. The amount of reflected light 47b may correspond to the amount of toner 31 on the developer member 14. For example, a signal received by the optical sensor 13 may vary based on the amount of reflected light 47b reflected from the developer member 14 based on the quantity of toner 31 and/or absence of toner 31 on the developer member 31 that contacts the light 47a. In some examples, the optical sensor 13 includes an optical reflectance sensor. The replacement indicator module 27 may also include a visual and/or audio indicator such as lights, text messages, sounds, and the like.

In some examples, the replacement indicator module 27 may be implemented in hardware, software including firmware, or combinations thereof. The firmware, for example, may be stored in memory and executed by a suitable instruction-execution system. If implemented in hardware, as in an alternative example, the replacement indicator module 27 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In other examples, the replacement indicator module 27 may be implemented in a combination of software and data executed and stored under the control of a computing device.

Referring to FIGS. 2-4A, in some examples, the light guiding device 12 may include at least one fiber optic cable 22. In some examples, the light guiding device 12 includes a plurality of fiber optic cables 22. For example, the light guiding device 12 may include a single fiber optic cable or a plurality of fiber optic cables as illustrated in FIG. 4A. As illustrated in FIG. 4A, the fiber optic cables 22 guide light 47a from the light source 11 to the plurality of areas 44a on the developer member 14. The fiber optic cables 22 may also guide the reflected light 47b from the developer member 14 to the optical sensor 13. Alternatively, the light guiding device 12 may include a lens assembly 42 to guide the light 47a received from the light source 11 into a plurality of light beams 47a at the plurality of areas 44a on the developer member 14, respectively, as illustrated in FIG. 4B. In some examples, the lens assembly 42 may include a single lens. Alternatively, the lens assembly 42 may include a plurality of lenses.

Referring to FIGS. 2-4B, in some examples, the toner cartridge 10 may also include a toner hopper 28, a resupply roller 23, and a charge roller 25. The toner supply hopper 28 stores the toner 31 to supply to the developer member 14. The resupply roller 23 supplies the toner 31 to the photosensitive member 15. The photosensitive member 15 may be initially charged, for example, by a charge roller 25 in contact therewith. In some examples, the image forming apparatus 200, such as a monochrome laser printer, may include a single toner cartridge. Alternatively, in some examples, the image forming apparatus 200, such as a color laser printer, may include a plurality of toner cartridges corresponding to different color toners.

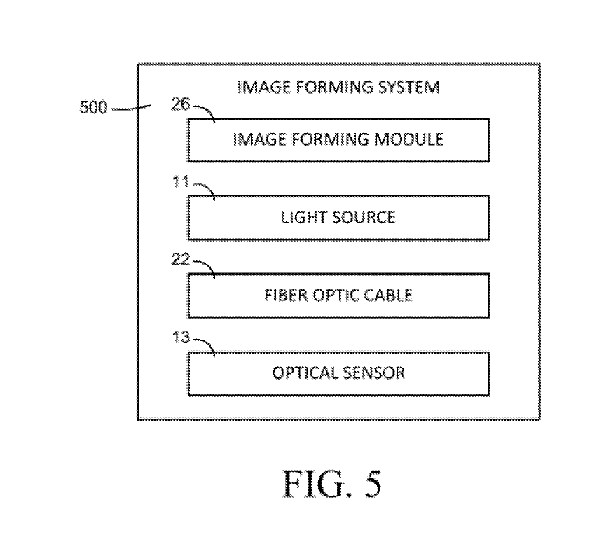

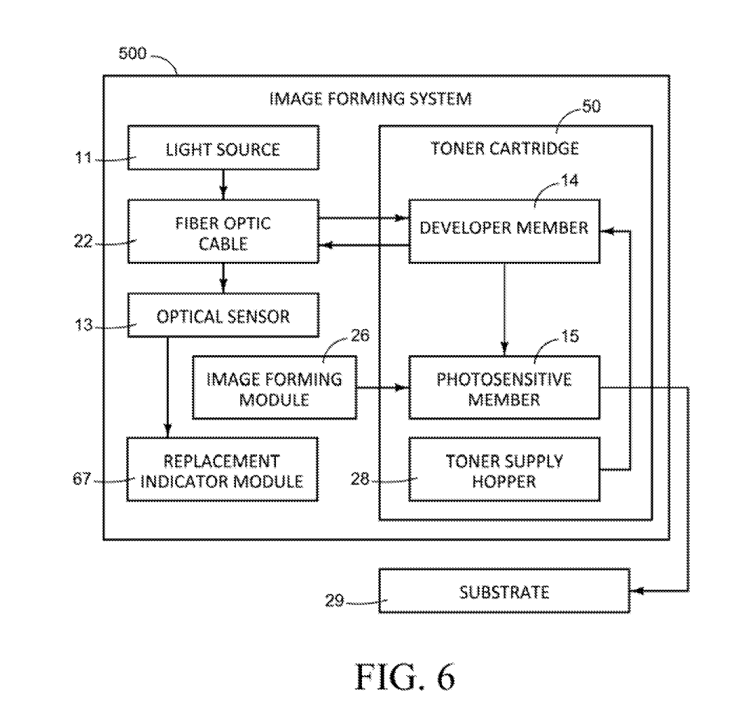

FIG. 5 is a block diagram illustrating an image forming system according to an example. FIG. 6 is a schematic view illustrating the image forming system of FIG. 5 according to an example. Referring to FIGS. 5 and 6, in some examples, an image forming system 500 includes a toner cartridge 50, an image forming module 26, a light source 11, an optical sensor 13, and at least one fiber optic cable 22. The toner cartridge 50 includes a developer member 14, a photosensitive member 15, and a toner supply hopper 28. The image forming module 26 emits light onto respective portions of a photosensitive member 15 to receive the toner from the developer member 14 of the toner cartridge 50, and to change a respective charge thereon to form a latent image thereon. The developer member 14 receives the toner 31 from the toner supply hopper 28 and applies the toner 31 to the respective portions of the photosensitive member 15. In some examples, the developer member 14 may include a developer roller and the photosensitive member 15 includes an organic photo conductor drum

Referring to FIGS. 5 and 6, in some examples, the light source 11 emits light. The optical sensor 13 detects an amount of reflected light reflected from the developer member 14. At least one fiber optic cable 22 guides the light from the light source 11 to the developer member 14. Subsequently, at least one fiber optic cable 22 also guides the reflected light from the developer member 14 to the optical sensor 13. In some examples, the at least one fiber optic cable 22 is configured to guide the light to a plurality of areas on the developer member 14. In some examples, the amount of reflected light detected by the optical sensor 13 corresponds to an amount of toner on the developer member 14. That is, in some examples, the detected amount of reflected light may correspond to whether toner 31 is present and/or in what quantities on an area and/or respective areas of the developer member 14. In some examples, the optical sensor 13 may detect reflected light at a plurality of areas of the developer member 14 to determine the amount of toner coverage of the developer member 14.

Referring to FIG. 6, in some examples, the image forming system 500 may also include a replacement indicator module 67. The replacement indicator module 67 may alert a user to replace the toner cartridge 50 based on the amount of toner 31 on the developer member 14. For example, a user may be alerted to replace the toner cartridge 50 based on the amount of toner 31 being less than a toner threshold value. For example, the optical sensor 13 may detect a respective value when the reflected light is reflected off of toner 31 on the developer member 14 and another respective value when the reflected light is reflected off of a portion of the developer member 14 itself that is absent of toner 31.

In some examples, the replacement indicator module 67 may be implemented in hardware, software including firmware, or combinations thereof. The firmware, for example, may be stored in memory and executed by a suitable instruction-execution system. If implemented in hardware, as in an alternative example, the replacement indicator module 67 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In other examples, the replacement indicator module 67 may be implemented in a combination of software and data executed and stored under the control of a computing device.

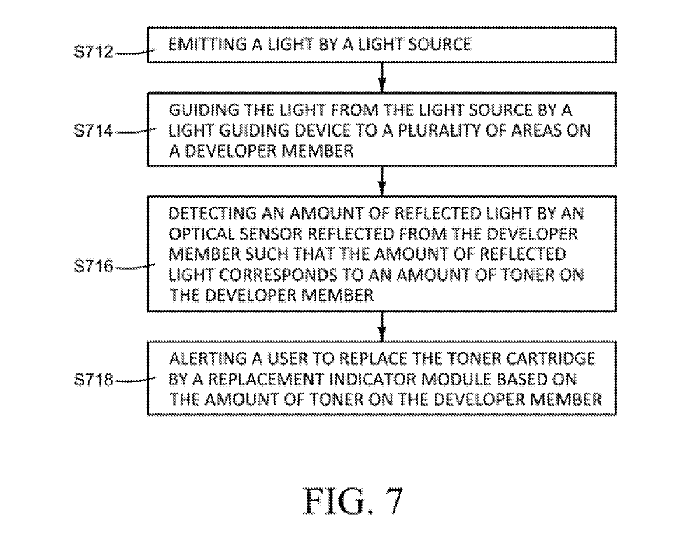

FIG. 7 is a flowchart illustrating a method of alerting a user to replace a toner cartridge according to an example. In block S712, light is emitted by a light source. In block S714, the light is guided from the light source by a light guiding device to a plurality of areas on the developer member. In some examples, the light guiding device includes a single fiber optic cable or a plurality of fiber optic cables. Alternatively, in some examples, the light guiding device includes a plurality of fiber optic cables, such that the reflected light reflected from the developer member is transmitted to the optical sensor by the plurality of fiber optic cables. In some examples, the light guiding device includes a lens assembly.

In block S716, an amount of reflected light is detected by an optical sensor reflected from the developer member such that the amount of reflected light corresponds to an amount of toner on the developer member. That is, in some examples, the detected amount of reflected light may correspond to whether toner is present and/or in what quantities on an area and/or respective areas of the developer member. In some examples, the optical sensor may detect reflected light at a plurality of areas of the developer member to determine the amount of toner coverage of the developer member.

In block S718, a user is alerted to replace the toner cartridge by a replacement indicator module based on the amount of toner on the developer member. For example, the user may be alerted to replace the toner cartridge when the amount of toner on the developer member is less than a toner threshold value. In some examples, the method may also include toner received by a developer member of a toner cartridge to apply the toner to a photosensitive member of the toner cartridge, and transmitting the toner received by the developer member to a substrate by the photosensitive member to form a printed image thereon. The method may also include transmitting the reflected light reflected from the developer member to the optical sensor by the at least one fiber optic cable.

It is to be understood that the flowchart of FIG. 7 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 7 illustrates a specific order of execution, the order of execution may differ from that which is depicted. For example, the order of execution of two or more blocks may be rearranged relative to the order illustrated. Also, two or more blocks illustrated in succession in FIG. 7 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. An image forming apparatus, comprising:
a light source to emit light;
a light guiding device to guide the light from the light source at a plurality of areas on a developer member of a toner cartridge;
an optical sensor to detect an amount of reflected light reflected from the developer member; and
wherein the amount of reflected light detected by the optical sensor corresponds to an amount of toner on the developer member.

2. The image forming apparatus of claim 1, wherein the light guiding device comprises at least one fiber optic cable.

3. The image forming apparatus of claim 1, wherein the light guiding device comprises:
a lens assembly to transmit the light received from the light source to a plurality of light beams at the plurality of areas on the developer member, respectively.

4. The image forming apparatus of claim 1, further comprising:
a replacement indicator module to alert a user to replace the toner cartridge based on the amount of toner coverage of the developer member being less than a toner threshold value.

5. The image forming apparatus of claim 1, wherein the light guiding device comprises a plurality of fiber optic cables.

6. The image forming apparatus of claim 3, wherein the tens assembly comprises:
at least one lens to transmit the light received from the light source to the plurality of light beams at the plurality of areas on the developer member, respectively.

7. An image forming system, comprising:
an image forming module to emit light onto respective portions of a photosensitive member to receive the toner from a developer member of a toner cartridge, and to change a respective charge thereon to form a latent image thereon;
a light source to emit light at the developer member;
an optical sensor to detect an amount of reflected light reflected from the developer member;
at least one fiber optic cable to guide the light from the light source to the developer member, and to guide the reflected light from the developer member to the optical sensor; and
wherein the amount of reflected light detected by the optical sensor corresponds to an amount of toner on the developer member.

8. The image forming system of claim 7, wherein the at least one fiber optic cable is configured to guide the light to a plurality of areas on the developer member.

9. The image forming system of claim 7, further comprising:
a replacement indicator module to alert a user to replace the toner cartridge based on the amount of toner on the developer member being less than a toner threshold value.

10. A method of alerting a user to replace a toner cartridge, the method comprising:
emitting a light by a light source;
guiding the light from the light source by a light guiding device to a plurality of areas on a developer member of the toner cartridge;
detecting an amount of reflected light by an optical sensor reflected from the developer member such that the amount of reflected light corresponds to an amount of toner coverage of the developer member; and
alerting a user to replace the toner cartridge by a replacement indicator module based on the amount of toner on the developer member.

11. The method of claim 10, wherein the light guiding device comprises a lens assembly.

12. The method of claim 10, wherein the light guiding device comprises at least one fiber optic cable.

13. The method of claim 12, further comprising:
transmitting the reflected light reflected from the developer member to the optical sensor by the at least one fiber optic cable.

14. The method of claim 10, wherein the light guiding device comprises a plurality of fiber optic cables.

15. The method of claim 14, further comprising:
transmitting the reflected light reflected from the developer member to the optical sensor by the plurality of fiber optic cables.
